(19) United States
(12) Patent Application Publication
(10) Pub. No.: US 2022/0389151 A1
(43) Pub. Date: Dec. 8, 2022

(54) COMPOSITION FOR 3D PRINTING

(71) Applicant: KYUNG-IN SYNTHETIC CORPORATION, Incheon (KR)

(72) Inventors: Kibeom KIM, Seoul (KR); Youlee PAE, Seoul (KR); Yeonjoon CHUNG, Seoul (KR)

(21) Appl. No.: 17/772,398

(22) PCT Filed: Nov. 12, 2020
(86) PCT No.: PCT/KR2020/015895

§ 371 Date: Apr. 27, 2022

(30) Foreign Application Priority Data
Nov. 28, 2019 (KR) 10-2019-0155200
Nov. 11, 2020 (KR) 10-2020-0150203

(51) Int. Cl. C08G 18/58; B33Y 70/00

(52) U.S. Cl. CPC C08G 18/58; B33Y 70/00

(57) ABSTRACT

The present invention relates to a composition for 3D printing and a preparation method therefor. The present invention can provide a composition for 3D printing, which is eco-friendly and has improved biocompatibility, and thus can be used for various applications including microfluidic materials, tooth and blood vessel mimicking materials, wearable device materials, robotic materials, and various other products.

### TECHNICAL FIELD

The present invention relates to a composition for 3D printing, which is eco-friendly and has improved biocompatibility and a method for manufacturing the same.

### BACKGROUND ART

3D printing technology is attracting attention as a core technology for various types of small-scale production being attempted in the Fourth Industrial Revolution. A wide range of applications can be found in microfluidic materials, tooth and blood vessel mimicking materials, wearable device materials, robotic materials and various other products.

3D printing materials that are currently commercially used are generally prepared via photopolymerization reaction using synthetic oligomers from petroleum.

However, using synthetic oligomers from petroleum is not eco-friendly and limits the production process due to the unpleasant odor of petrochemical products peculiar to the raw material, and there may arise the problems in the biocompatibility and skin toxicity of users using 3D printed products.

Therefore, there is a need for research on a composition for 3D printing prepared from natural materials and a method for manufacturing the same.

### DETAILED DESCRIPTION OF THE INVENTION

### Technical Problem

It is an object of the present invention to provide a composition for 3D printing produced from natural materials by replacing synthetic oligomers from petroleum.

It is also to provide a method of providing the composition.

### Solution to Problem

In order to solve the above problems, the present invention provides a composition for 3D printing comprising acrylated epoxidized vegetable oil oligomers.

According to other aspect of the present invention, there is provided a method for manufacturing a composition for 3D printing, comprising:

epoxidizing a vegetable oil; and

acrylating the epoxidized vegetable oil to produce acrylated epoxidized vegetable oil oligomers.

According to one embodiment, the epoxidation reaction comprises reacting by adding an organic acid or an inorganic acid to the vegetable oil, and adding hydrogen peroxide or peracid,

wherein the inorganic acid comprises one or more selected from the group consisting of hydrochloric acid, sulfuric acid, nitric acid, hydrofluoric acid, carbonic acid, phosphoric acid, phosphorous acid, hypophosphorous acid, and perchloric acid,

the organic acid comprises one or more selected from the group consisting of formic acid, acetic acid, propionic acid, malic acid, citric acid, succinic acid, oxalic acid, citric acid, fumaric acid, tartaric acid and pyruvic acid,

the peracid comprises one or more selected from the group consisting of perchloric acid, peracetic acid, perbenzoic acid, urea peroxide, meta-chloroperbenzoic acid, tert-butyl hydroperoxide, acetone peroxide, methyl ethyl ketone peroxide, hexamethylene triperoxide and cumene hydroperoxide.

According to one embodiment, the method further comprises washing with a solvent and purified water and then removing the solvent, after the epoxidation reaction,

wherein the solvent may comprise one or more selected from the group consisting of toluene, xylene, ethyl acetate, hexane, cyclohexane, heptane, methylene chloride and chloroform.

According to one embodiment, the acrylation reaction may comprise reacting the epoxidized vegetable oil with one or more selected from the group consisting of acrylic acid, methacrylic acid, acrylic anhydride and methacrylic anhydride.

According to one embodiment, the catalyst for the acrylation may comprise one or more selected from the group consisting of benzyltriethylammonium chloride, tetramethylammonium chloride, tetraethylammonium chloride, benzyltriethylammonium bromide, tetramethylammonium bromide, tetraethylammonium bromide, tetrabutylammonium chloride and tetrabutylamnioniuni bromide.

According to one embodiment, the method may further comprise neutralization using a solvent and an alkaline aqueous solution and then removing the solvent, after the acrylation reaction.

In addition, the solvent may comprise one or more selected from the group consisting of toluene, xylene, ethyl acetate, hexane, cyclohexane, heptane, methylene chloride and chloroform.

In addition, the alkaline aqueous solution may comprise one or more selected from the group consisting of sodium hydroxide, potassium hydroxide, sodium carbonate, potassium carbonate, calcium carbonate and sodium hydrogen carbonate.

According to one embodiment, the composition may contain 30 to 80% by weight of the acrylated epoxidized vegetable oil oligomers based on the total weight of the composition.

According to one embodiment, the composition may further comprise one or more selected from the group consisting of photocurable urethane oligomers, photocurable monomers, and a photoinitiator.

The specific details of other embodiments of the invention are included in the detailed description below.

### Effect of the Invention

According to the present invention, it is possible to provide a composition for 3D printing that is environmentally friendly and has improved biocompatibility and thus it is possible to minimize the effect on the human body while maintaining an excellent implementation rate of the 3D printed product. In addition, the composition can be used for various applications including microfluidic materials, tooth and blood vessel mimicking materials, wearable device materials, robotic materials, and various other products.

### BRIEF DESCRIPTION OF DRAWINGS

FIG. 1 is a photograph of an output of the composition for 3D printing according to an embodiment of the present invention.

FIG. 2 is a manufacturing drawing for Experimental Example 1.

### BEST MODE FOR CARRYING OUT THE INVENTION

Since various modifications and variations can be made in the present invention, particular embodiments are illustrated in the drawings and will be described in detail in the detailed description. It should be understood, however, that the invention is not intended to be limited to the particular embodiments, but includes all modifications, equivalents, and alternatives falling within the spirit and scope of the invention. In the following description of the present invention, detailed description of known functions will be omitted if it is determined that it may obscure the gist of the present invention.

Hereinafter, a composition for 3D printing and a method for manufacturing the same will be described in more detail in an embodiment of the present invention.

The present invention relates to a composition for 3D printing comprising acrylated epoxidized vegetable oil oligomers and a method for manufacturing the same, wherein the acrylated epoxidized vegetable oil oligomers may be obtained by sequentially performing epoxidation and acrylation on a natural vegetable oil.

According to one embodiment, the epoxidation reaction may include adding hydrogen peroxide or peracid in the presence of a vegetable oil and a catalyst, and an example of the reaction is shown in Scheme 1.

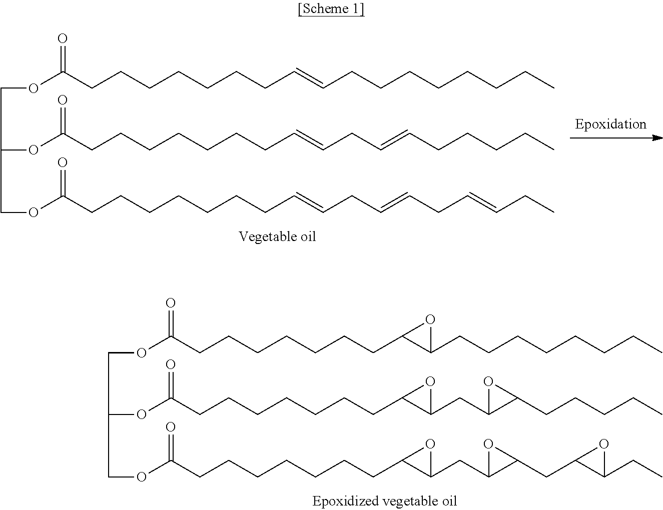 [SMILES: CC/C=C/C/C=C/C/C=C/CCCCCCCC(=O)OCC(COC(=O)CCCCCCC/C=C/CCCCCCCC)OC(=O)CCCCCCC/C=C/C/C=C/CCCCC ; CCCCCCCCC1OC1CCCCCCCC(=O)OCC(COC(=O)CCCCCCCC1OC1CC1OC1CC1OC1CC)OC(=O)CCCCCCCC1OC1CC1OC1CCCCC]

According to one embodiment, an organic acid or an inorganic acid may be used as a catalyst for the epoxidation reaction. The organic acid and inorganic acid of the present invention do not include a compound in the form of a peracid having a —C(═O)—O—O—H structure. The organic acid may comprise, for example, one or more selected from formic acid, acetic acid, propionic acid, malic acid, citric acid, succinic acid, oxalic acid, citric acid, fumaric acid, tartaric acid and pyruvic acid. The inorganic acid may comprise, for example, one or more selected from hydrochloric acid, sulfuric acid, nitric acid, hydrofluoric acid, carbonic acid, phosphoric acid, phosphorous acid, hypophosphorous acid, and perchloric acid.

According to one embodiment, the peracid may comprise, for example, one or more selected from the group consisting of perchloric acid, peracetic acid, perbenzoic acid, urea peroxide, meta-chloroperbenzoic acid, tert-butyl hydroperoxide, acetone peroxide, methyl ethyl ketone peroxide, hexamethylene triperoxide and cumene hydroperoxide.

According to one embodiment, the method according to the present invention may further comprise washing with a solvent and purified water and then removing the solvent, after the epoxidation reaction.

The solvent may comprise one or more selected from the group consisting of toluene, xylene, ethyl acetate, hexane, cyclohexane, heptane, methylene chloride and chloroform, and for example, toluene may be used. In addition, purified water may include distilled water, deionized water, and the like, and is not particularly limited as long as it is generally used purified water.

According to one embodiment, the natural vegetable oil used as a raw material of the present invention may comprise, for example, one or more selected from soybean oil, olive oil, linseed. oil, cottonseed oil, grape seed oil, palm oil, sunflower seed oil, coconut oil, rapeseed oil, etc. The vegetable oil may be appropriately selected according to the number of functional groups of the epoxidized vegetable oil, which is an epoxidation reaction product, and the purpose of use, and is not particularly limited to those described above.

According to one embodiment, the present invention can synthesize acrylated epoxidized vegetable oil oligomers by acrylation with one or more from the group consisting of acrylic acid, methacrylic acid, acrylic anhydride, methacrylic anhydride, etc. in the presence of the epoxidized vegetable oil and a catalyst. The reaction process according to an embodiment of the present invention is shown in Scheme 2.

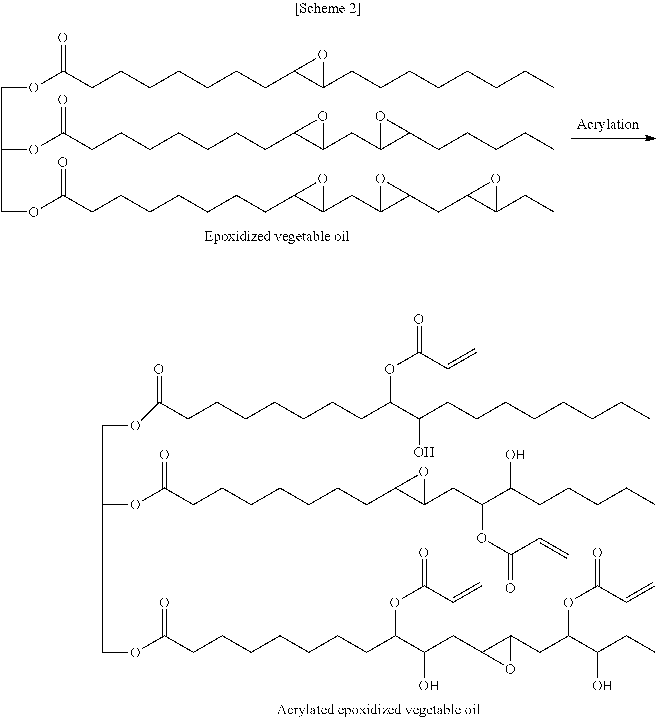 [SMILES: CCCCCCCCC1OC1CCCCCCCC(=O)OCC(COC(=O)CCCCCCCC1OC1CC1OC1CC1OC1CC)OC(=O)CCCCCCCC1OC1CC1OC1CCCCC ; C=CC(=O)OC(CCCCCCCC(=O)OCC(COC(=O)CCCCCCCC(OC(=O)C=C)C(O)CC1OC1CC(OC(=O)C=C)C(O)CC)OC(=O)CCCCCCCC1OC1CC(OC(=O)C=C)C(O)CCCCC)C(O)CCCCCCCC]

According to one embodiment, the catalyst acrylation may comprise one or more selected from the group consisting of benzyltriethylammonium chloride, tetramethylammonium chloride, tetraethylammonium chloride, benzyhriethylammonium bromide, tetramethylammonium bromide, tetraethylammonium bromide, tetrabutylammonium chloride and tetrabutylammonium bromide.

According to one embodiment, the present invention may comprise neutralization using a solvent and an alkaline aqueous solution and then removing the solvent, after the epoxidation reaction, that is, after oligomer synthesis. For example, one or more selected from the group consisting of toluene, xylene, ethyl acetate, hexane, cyclohexane, heptane, methylene chloride and chloroform may be used as the solvent. The alkaline salt contained in the alkaline aqueous solution may comprise one or more selected from the group consisting of sodium hydroxide, potassium hydroxide, sodium carbonate, potassium carbonate, calcium carbonate and sodium hydrogen carbonate.

According to one embodiment, the composition may further comprise one or more selected from the group consisting of photocurable urethane oligomers, photocurable monomers, and a photoinitiator. They are not particularly limited as long as they are generally used as additives, and may be appropriately selected. The photocurable urethane oligomers may comprise, for example, one or more selected from oligomers having any one selected from the group consisting of polyether polyol, polytetramethylene glycol, polycaprolactone, polyester polyol, and a combination thereof, as a main chain; any one selected from the group consisting of isophorone diisocyanate, hexamethylene diisocyanate, toluene diisocyanate and a combination thereof, as an isocyanate group; and any one selected from the group consisting of hydroxyethyl acrylate, hydroxypropyl acrylate, hydroxybutyl acrylate, hydroxyethyl methacrylate, hydroxypropyl methacrylate, hydroxybutyl methacrylate and a combination thereof, as a reactive functional group.

The photocurable monomers may comprise, for example, one or more selected from the group consisting of isobornyl (meth)acrylate, ethylhexyl (meth)acrylate, isopropyl (meth)acrylate, lauryl (meth)acrylate, polyethylene glycol di(meth)acrylate, dicyclopentadiene (meth)acrylate, stearyl (meth)acrylate, dipentaerythritol pentaacrylate, pentaerythritol tetraacrylate and trimethylol tri(meth)acrylate.

The photoinitiator may comprise, for example, one or more selected from the group consisting of 2,4,6-trimethylbenzoyldiphenylphosphine oxide, benzoinmethyl ether, bis(2,4,6-trimethylbenzoyl)phenylphosphine oxide, 2-benzyl-2-(dimethylamino)-1-[4-(4-morpholinyl)phenyl]-1-butanone, 2,2-dimethoxy-2-phenylacetophenone, 1-hydroxy-cyclohexyl-phenylketone, α,α-methoxy-α-hydroxyacetophenone, 2-benzoyl-2-(dimethylamino)-1-[4-(4-morpholino)phenyl]-butanone and 2,2-dimethoxy-1,2-diphenylethane-1-one.

According to one embodiment, the composition according to the present invention may contain 30 to 80% by weight of the acrylated epoxidized vegetable oil oligomers based on the total weight of the composition, for example 40% by weight or more, for example 50% by weight or more, and 80% by weight or less, for example 70% by weight or less.

The composition manufactured by the method as described above is eco-friendly and can have improved biocompatibility, thereby minimizing the effect on the human body. Therefore, it can be used for various applications requiring biocompatibility such as tooth and blood vessel mimicking materials, wearable device materials, etc.

Hereinafter, embodiments of the present invention will be described in detail so that those of ordinary skill in the art can easily carry out the present invention. However, the present invention may be embodied in several different forms and is not limited to the embodiments described herein.

### PREPARATION EXAMPLE 1

### Preparation of Epoxidized Soybean Oil

100 g of soybean oil and 13.97 g of formic acid were introduced to a reactor and warmed to 50° C. with stirring. After the temperature rise was completed, 100.25 g of 35% H₂O₂ aqueous solution was added dropwise over 3 hours and stirred for 15 hours. After the reaction was completed, toluene was added and stirred for 30 minutes. It was transferred to a separatory funnel and left for 30 minutes to remove the aqueous layer.

Then, a process was repeated 3 times in which purified water was added, stirred for 10 minutes and left for 30 minutes to remove the separated aqueous layer. 1.05.15 g of epoxidized soybean oil was obtained from the oil layer.

### PREPARATION EXAMPLE 2

### Preparation of Epoxidized Cottonseed Oil

100 g of cottonseed oil and 12.69 g of formic acid were introduced to a reactor and warmed to 50° C. with stirring. After the temperature rise was completed, 91.03 g of 35% H₂O₂ aqueous solution was added dropwise over 3 hours and stirred for 15 hours. After the reaction was completed, toluene was added and stirred for 30 minutes. It was transferred to a separatory funnel and left for 30 minutes to remove the aqueous layer. Then, a process was repeated 3 times in which purified water was added, stirred for 10 minutes and left for 30 minutes to remove the separated aqueous layer. 100.54 g of epoxidized cottonseed oil was obtained from the oil layer.

### PREPARATION EXAMPLE 3

### Preparation of Epoxidized Olive Oil

100 g of olive oil and 9.03 g of formic acid were introduced to a reactor and warmed to 50° C. with stirring. After the temperature rise was completed, 64.79 g of 35% H₂O₂ aqueous solution was added dropwise over 3 hours and stirred for 15 hours. After the reaction was completed, toluene was added and stirred for 30 minutes. It was transferred to a separatory funnel and left for 30 minutes to remove the aqueous layer. Then, a process repeated was 3 times in which purified water was added, stirred for 10 minutes and left for 30 minutes to remove the separated aqueous layer. 103.48 g of epoxidized olive oil was obtained from the oil layer.

### PREPARATION EXAMPLE 4

### Preparation of Epoxidized Palm Oil

100 g of palm oil and 5.27 g of formic acid were introduced to a reactor and warmed to 50° C. with stirring. After the temperature rise was completed, 37.83 g of 35% H₂O₂ aqueous solution was added dropwise over 3 hours and stirred for 15 hours. After the reaction was completed, toluene was added and stirred for 30 minutes. It was transferred to a separatory funnel and left for 30 minutes to remove the aqueous layer. Then, a process was repeated 3 times in which purified water was added, stirred for 10 minutes and left for 30 minutes to remove the separated aqueous layer. 98.74 g of epoxidized palm oil was obtained from the oil layer.

### PREPARATION EXAMPLE 5

### Preparation of Acrylated Epoxidized Soybean Oil

100 g of epoxidized soybean oil which is the product according to Preparation Example 1, 33.78 g of acrylic acid, 0.54 g of hydroquinone monomethyl ether, 0.54 g of butylhydroxytoluene, and 1.34 g of benzyltriethylammonium chloride were introduced to a reactor and warmed to 110° C. with stirring. After the temperature rise was completed, the reaction was carried out with stirring for 15 hours. After the reaction was completed, ethyl acetate and 0.5% NaHCO₃ aqueous solution were added and stirred for 30 minutes. It was transferred to a separatory funnel and left for 30 minutes to remove the aqueous layer. Then, a process was repeated 2 times in which purified water was added, stirred for 10 minutes and left for 30 minutes to remove the separated aqueous layer. 123.14 g of acrylated epoxidized soybean oil was obtained from the oil layer.

### PREPARATION EXAMPLE 6

### Preparation of Acrylated Epoxidized Cottonseed Oil

100 g of epoxidized cottonseed oil according to Preparation Example 2, 29.56 g of acrylic acid, 0.52 g of hydroquinone monomethyl ether, 0.52 g of butylhydroxytoluene, and 1.30 g of benzyltriethylammonium chloride were introduced to a reactor and warmed to 110° C. with stirring. After the temperature rise was completed, the reaction was carried out with stirring for 15 hours. After the reaction was completed, ethyl acetate and 0.5% NaHCO₃ aqueous solution were added and stirred for 30 minutes. It was transferred to a separatory funnel and left for 30 minutes to remove the aqueous layer. Then, a process was repeated 2 times in which purified water was added, stirred for 10 minutes and left for 30 minutes to remove the separated aqueous layer. 111.42 g of acrylated epoxidized cottonseed oil was obtained from the oil layer.

### PREPARATION EXAMPLE 7

### Preparation of Acrylated Epoxidized Olive Oil

100 g of epoxidized olive oil according to Preparation Example 3, 22.12 g of acrylic acid, 0.24 g of hydroquinone monomethyl ether, 0.24 g of butylhydroxytoluene, and 1.22 g of benzyltriethylammonium chloride were introduced to a reactor and warmed to 110° C. with stirring. After the temperature rise was completed, the reaction was carried out with stirring for 15 hours. After the reaction was completed, ethyl acetate and 0.5% NaHCO₃ aqueous solution were added and stirred for 30 minutes. It was transferred to a separatory funnel and left for 30 minutes to remove the aqueous layer. Then, a process was repeated 2 times in which purified water was added, stirred for 10 minutes and left for 30 minutes to remove the separated aqueous layer. 113.91 g of acrylated epoxidized olive oil was obtained from the oil layer.

### PREPARATION EXAMPLE 8

### Preparation of Acrylated Epoxidized Palm Oil

100 g of epoxidized palm oil according to Preparation Example 4, 13.12 g of acrylic acid, 0.23 g of hydroquinone monomethyl ether, 0.23 g of butylhydroxytoluene, and 1.14 g of benzyhriethylammonium chloride were introduced to a reactor and warmed to 110°C. with stirring. After the temperature rise was completed, the reaction was carried out with stirring for 15 hours. After the reaction was completed, ethyl acetate and 0.5% NaHCO₃ aqueous solution were added and stirred for 30 minutes. It was transferred to a separatory funnel and left for 30 minutes to remove the aqueous layer. Then, a process was repeated 2 times in which purified water was added, stirred for 10 minutes and left for 30 minutes to remove the separated aqueous layer. 105.84 g of acrylated epoxidized palm oil was obtained from the oil layer.

### EXAMPLE 1

### Preparation of a Composition for 3D Printing Comprising Acrylated Epoxidized Soybean Oil

50 g of acrylated epoxidized soybean oil according to Preparation Example 5, 14 g of urethane acrylate oligomers, 26.25 g of isobornyl acrylate, 8.75 g of 2-ethylhexyl acrylate, 0.5 g of 2,4,6-trimethylbenzoyldiphenylphosphine oxide and 0.5 g of diethylthioxanthenone (2,4-diethyl-thioxanthen-9-one) were introduced to a reactor and warmed to 50° C. with stirring. After the temperature rise was completed, it was stirred for 1 hour until dissolution of all crystals is confirmed, resulting in a composition for 3D printing.

### EXPERIMENTAL EXAMPLE 1

### Preparation of Molded Article

A specimen for tensile testing was prepared using the composition for 3D printing according to Example 1. The shape of the prepared specimen is defined according to ASTM D628-14 Type IV (2014).

The specimen was prepared to a thickness of 100 tm per layer using a VITTRO LITE DLP 3D printer of 3D Light and the product was post-cured with VITTRO Q50 of 3D Light for 3 minutes. The actual dimensions of the prepared specimen were measured with a digital caliper of APT and evaluated in the difference with those of manufacturing drawing to determine whether the prepared specimen was expanded or contracted.

From the composition for 3D printing according to Example 1, which prepared from 50 g of acrylated epoxidized soybean oil, 14 g of urethane acrylate oligomers, 26.25 g of isobornyl acrylate, 8.75 g of 2-ethylhexyl acrylate, 0.5 g of 2,4,6-trimethylbenzoyldiphenylphosphine oxide and 0.5 g of diethylthioxanthenone, a molded article of Sample 1 was manufactured by using a DLP 3D printer in a constant temperature state maintained at 25° C. It was confirmed that there was almost no odor peculiar to synthetic monomers made from petroleum during the manufacturing process.

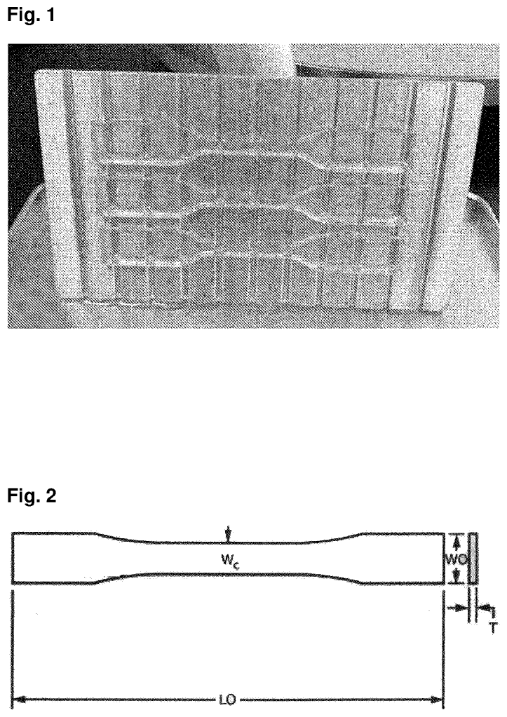

A photograph of Sample 1 is shown in FIG. 1, and a manufacturing drawing is shown n FIG. 2. In addition, the coincidence rate between the manufacturing drawing and Sample 1 is shown in Table 1.

TABLE 1

| | Manufacturing | Experimental | Coincidence |
|---|---|---|---|
| Item | drawing (mm) | Example (mm) | rate (%) |
| LO | 115.00 | 114.30 | 99.4% |
| W | 6.00 | 6.00 | 100% |
| WO | 19.00 | 18.98 | 99.9% |
| T | 4.00 | 3.98 | 99.5% |

As shown Table 1, the actual dimensions of the post-cured specimen were measured and compared with the dimensions of the manufacturing drawing of FIG. 2 to confirm to have a 99.4˜100% coincidence rate for each part. In addition, as shown in FIGS. 1 and 2, it was confirmed that the molded article was manufactured without a difference between the manufacturing drawing and the actual product in appearance.

As can be seen from the above results, it can be confirmed that the implementation on molding of the composition for 3D printing according to the present invention is excellent. In addition, the composition for 3D printing according to present invention is eco-friendly and has the minimized adverse effects on human body by using natural vegetable oil as a raw material, and thus can be used for various applications requiring biocompatibility such as tooth and blood vessel mimicking materials, wearable device materials, etc.

The above descriptions are merely illustrative of the technical idea of the present invention, and those of ordinary skill in the technical field to which the present invention pertains can make various modifications and variations without departing from the essential characteristics of the present invention. In addition, the embodiments disclosed in the present invention are not intended to limit the technical idea of the present invention, but to explain the technical idea, and the scope of the technical idea of the present invention is not limited by these embodiments. The scope of protection of the present invention should be interpreted by the appended claims, and all technical ideas within the scope equivalent thereto should be interpreted as being included in the scope of the present invention.

1. A composition for 3D printing comprising acrylated epoxidized vegetable oil oligomers.

2. A method for manufacturing a composition for 3D printing, comprising:
epoxidizing a vegetable oil; and
acrylating the epoxidized vegetable oil to produce acrylated epoxidized vegetable oil oligomers.

3. The method for manufacturing a composition for 3D printing according to claim 2, wherein:
the epoxidation reaction comprises reacting by adding an organic acid or an inorganic acid to the vegetable oil, and adding hydrogen peroxide or peracid,
the inorganic acid comprises one or more selected from the group consisting of hydrochloric acid, sulfuric acid, nitric acid, hydrofluoric acid, carbonic acid, phosphoric acid, phosphorous acid, hypophosphorous acid, and perchloric acid,
the organic acid comprises one or more selected from the group consisting of formic acid, acetic acid, propionic acid, malic acid, citric acid, succinic acid, oxalic acid, citric acid, fumaric acid, tartaric acid and pyruvic acid,
the peracid comprises one or more selected from the group consisting of perchloric acid, peracetic acid, perbenzoic acid, urea peroxide, meta-chloroperbenzoic acid, tert-butyl hydroperoxide, acetone peroxide, methyl ethyl ketone peroxide, hexamethylene triperoxide and cumene hydroperoxide.

4. The method for manufacturing a composition for 3D printing according to claim 2, further comprising washing with a solvent and purified water and then removing the solvent, after the epoxidation reaction,
wherein the solvent comprises one or more selected from the group consisting of toluene, xylene, ethyl acetate, hexane, cyclohexane, heptane, methylene chloride and chloroform.

5. The method for manufacturing a composition for 3D printing according to claim 2, wherein the acrylation reaction comprises reacting the epoxidized vegetable oil with one or more selected from the group consisting of acrylic acid, methacrylic acid, acrylic anhydride and methacrylic acid anhydride.

6. The method for manufacturing a composition for 3D printing according to claim 2, wherein the catalyst for the acrylation comprises one or more selected from the group consisting of benzyltriethylammonium chloride, tetramethylammonium chloride, tetraethylammonium chloride, benzyltriethylammonium bromide, tetramethylammonium bromide, tetraethylammonium bromide, tetrabutylammonium chloride and tetrabutylammonium bromide.

7. The method for manufacturing a composition for 3D printing according to claim 2, further comprising neutralization using a solvent and an alkaline aqueous solution and then removing the solvent, after the acrylation reaction,
wherein the solvent comprises one or more selected from the group consisting of toluene, xylene, ethyl acetate, hexane, cyclohexane, heptane, methylene chloride and chloroform, and
the alkaline aqueous solution comprises one or more selected from the group consisting of sodium hydroxide, potassium hydroxide, sodium carbonate, potassium carbonate, calcium carbonate and sodium hydrogen carbonate.

8. The composition for 3D printing according to claim 1, wherein the composition contains 30 to 80% by weight of the acrylated epoxidized vegetable oil oligomers based on the total weight of the composition.

9. The composition for 3D printing according to claim 1, wherein the composition further comprises one or more selected from the group consisting of photocurable urethane oligomers, photocurable monomers, and a photoinitiator.
